(19) United States
(12) Patent Application Publication
(10) Pub. No.: US 2008/0240245 A1
(43) Pub. Date: Oct. 2, 2008

(54) IMAGE ENCODING/DECODING METHOD AND APPARATUS

(75) Inventors: Kyo-hyuk LEE, Yongin-si (KR); Woo-jin HAN, Suwon-si (KR); So-young KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/018,534

(22) Filed: Jan. 23, 2008

(30) Foreign Application Priority Data
Mar. 28, 2007 (KR) 10-2007-0030375

(51) Int. Cl. H04N 7/26

(52) U.S. Cl. 375/240.16; 375/E07.125

(57) ABSTRACT

Provided are an image encoding/decoding method and apparatus, which assign a virtual motion vector to a block that is encoded in an intra prediction mode and generate a new prediction block that is a combination of a prediction block generated by motion compensation using the virtual motion vector and another prediction block generated by intra prediction.

### CROSS-REFERENCE TO RELATED PATENT APPLICATIONS

This application claims priority from Korean Patent Application No. 10-2007-0030375, filed on Mar. 28, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to image encoding/decoding, and more particularly, to image encoding/decoding using a new predictor, which is a combination of a predictor generated by intra prediction and a predictor generated by motion compensation using a virtual motion vector assigned to a block which is encoded in an intra prediction mode.

2. Description of the Related Art

Video compression standards such as Moving Picture Experts Group 1 (MPEG-1), MPEG-2, MPEG-4, and H.264/Advanced Video Coding (AVC) encode a picture by dividing it into macroblocks. Each macroblock is encoded in all encoding modes in which inter prediction and intra prediction may be used. One of the encoding modes is selected according to a bitrate required to encode each macroblock and a distortion level between each original macroblock and decoded macroblock.

Intra prediction calculates a prediction value of a current block that is to be encoded using a pixel value spatially neighboring the current block, and encodes the difference between the prediction value and the pixel value. Inter prediction searches for an area of a reference picture similar to a currently encoded block using at least one reference picture before or after the currently encoded block, to generate a motion vector, and encodes the difference between a prediction block obtained by performing motion compensation using the motion vector and the currently encoded block.

In the related art, an intra prediction mode or an inter prediction mode is used to form a prediction block corresponding to a current block, a cost is calculated using a predetermined cost function, the mode having the minimum cost is selected, and encoding is performed. As a result, compression efficiency is improved.

However, a method of encoding an image having improved compression efficiency is needed in order to overcome limited transmission bandwidth and provide a user with a high quality image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image encoding method and apparatus that improves encoding efficiency of an image.

The present invention also provides an image decoding method and apparatus that efficiently decodes encoded image data.

According to an aspect of the present invention, there is provided an image encoding method including generating a virtual motion vector of an intra block which is encoded by intra prediction, by using motion information of an area neighboring the intra block; generating a first prediction block of the intra block by performing motion compensation using the virtual motion vector; generating a second prediction block of the intra block by performing intra prediction for the intra block in a predetermined prediction direction; and generating a final prediction block of the intra block by combining the first prediction block and the second prediction block.

According to another aspect of the present invention, there is provided an image encoding apparatus including a virtual motion vector generator which generates a virtual motion vector of an intra block which is encoded by intra prediction, based on motion information of an area which neighbors the intra block; a motion compensation unit which generates a first prediction block of the intra block by performing motion compensation using the virtual motion vector; an intra prediction unit which generates a second prediction block of the intra block by performing intra prediction for the intra block in a predetermined prediction direction; and a combination unit which generates a final prediction block of the intra block by combining the first prediction block and the second prediction block.

According to another aspect of the present invention, there is provided an image decoding method including generating a virtual motion vector of a current block that is to be decoded using motion information on an area neighboring the current block; generating a first prediction block of the current block by performing motion compensation using the virtual motion vector; generating a second prediction block of the current block by performing intra prediction using a previously decoded block neighboring the current block before the current block is decoded; generating a final prediction block of the current block by combining the first prediction block and the second prediction block; and decoding the current block by reconstructing a residue included in a received bitstream and adding the residue to the final prediction block.

According to another aspect of the present invention, there is provided an image decoding apparatus including a virtual motion vector generation unit which generates a virtual motion vector of a current block that is to be decoded using motion information on an area neighboring the current block; a motion compensation unit which generates a first prediction block of the current block by performing motion compensation using the virtual motion vector; an intra prediction unit which generates a second prediction block of the current block by performing intra prediction based on a previously decoded block which neighbors the current block before the current block is decoded; a combination unit which generates a final prediction block of the current block by combining the first prediction block and the second prediction block; a residue reconstruction unit which reconstructs a residue included in a received bitstream; and an addition unit which decodes the current block by adding the residue to the final prediction block.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an image encoding apparatus according to an exemplary embodiment of the present invention;

FIG. 2 is a diagram illustrating generating a virtual motion vector assigned to an intra block according to an exemplary embodiment of the present invention;

FIG. 3 is a diagram illustrating generating a virtual motion vector assigned to an intra block according to another exemplary embodiment of the present invention;

FIG. 4 illustrates 4×4 intra prediction modes according to an exemplary embodiment of the present invention;

FIG. 5 illustrates 16×16 intra prediction modes according to an exemplary embodiment of the present invention;

FIG. 6 is a flowchart illustrating an image encoding method according to an exemplary embodiment of the present invention;

FIG. 7 is a block diagram of an image decoding apparatus according to an exemplary embodiment of the present invention; and

FIG. 8 is a flowchart illustrating an image decoding method according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

An image encoding method and apparatus according to an exemplary embodiment of the present invention assign to an intra block a virtual motion vector generated using motion information of an area neighboring the intra block, generate a final predictor that is a combination of a predictor generated by motion compensation using the virtual motion vector assigned to the intra block and another predictor generated by intra prediction, and encode a residue that is the difference between an original pixel block and the final predictor. The process of generating a new predictor will now be described, based on the assumption that each block of an input image is classified as either an intra predicted block (hereinafter referred to as an “intra block”) or an inter predicted block (hereinafter referred to as an “inter block”).

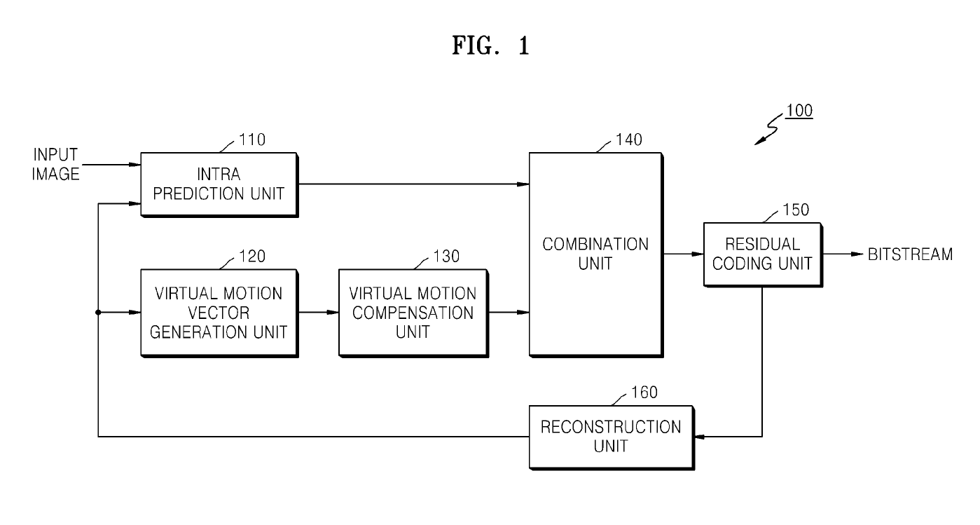

FIG. 1 is a block diagram of an image encoding apparatus 100 according to an exemplary embodiment of the present invention. Referring to FIG. 1, the image encoding apparatus 100 includes an intra prediction unit 110, a virtual motion vector generation unit 120, a virtual motion compensation unit 130, a combination unit 140, a residual coding unit 150, and a reconstruction unit 160.

The virtual motion vector generation unit 120 generates a virtual motion vector by using motion information of an area neighboring an intra prediction encoded block, and assigns the virtual motion vector to the intra prediction encoded block. In the related art, when an intra block is encoded, only residue information is encoded, without generating a motion vector. Residue information is the difference between the intra block and a prediction block predicted from neighboring blocks in the same picture. However, according to an exemplary embodiment of the present invention, in order to perform motion compensation of the intra block, the virtual motion vector generation unit 120 assigns to the intra block the virtual motion vector generated using motion information of the area neighboring the intra block. Also, a prediction block generated by performing motion compensation using the virtual motion vector assigned to the intra block is combined with another prediction block generated by intra prediction to generate a new prediction block, thus resulting in more efficient prediction according to the image characteristics.

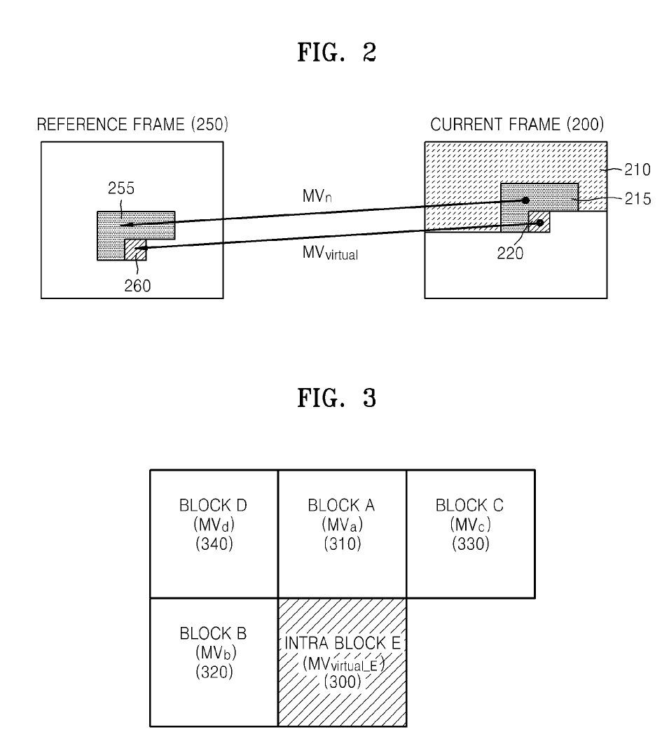

FIG. 2 is a diagram illustrating generating a virtual motion vector assigned to an intra block according to an exemplary embodiment of the present invention. Referring to FIG. 2, an intra block 220 is currently being intra prediction encoded, and an area 215 neighboring (that is contiguous with) the intra block 220 is encoded and reconstructed before the intra block 220.

The virtual motion vector generation unit 120 performs motion estimation of the area 215 neighboring the intra block 220, and determines a motion vector (MVₙ) indicating a corresponding area 255 of a reference frame 250, which is similar to the neighboring area 215. The virtual motion vector generation unit 120 sets a virtual motion vector MVᵥᵢᵣₜᵤₐₗ of the intra block 320 equal to the motion vector MVₙ of the neighboring area 215. That is, the virtual motion vector generation unit 120 sets a motion vector having the same magnitude and direction as the motion vector MVₙ of the neighboring area 215, as the virtual motion vector MVᵥᵢᵣₜᵤₐₗ of the intra block 220. As described before, the virtual motion vector MVᵥᵢᵣₜᵤₐₗ of the intra block 220 is used to perform motion prediction of the intra block 220.

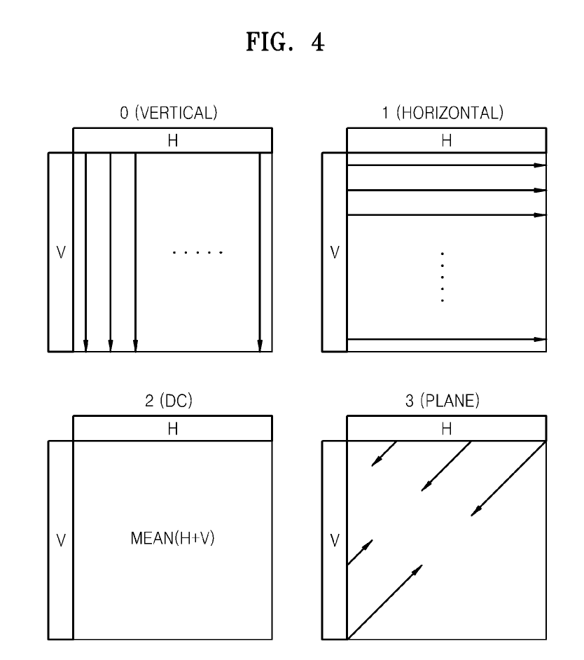

FIG. 3 is a diagram illustrating another example of generating a virtual motion vector assigned to an intra block according to another exemplary embodiment of the present invention. Referring to FIG. 3, an intra block E 300 is currently being encoded, and blocks A through D 310 through 340 neighboring the intra block E 300 may each be an inter block or an intra block. It is assumed that an inter block in the blocks A through D has a motion vector which is generated through a conventional motion prediction process performed in the prediction image generation unit 210. An intra block in the blocks A through D has a virtual motion vector which is determined through a motion prediction process using a neighboring area, as described above with reference to FIG. 2, or a virtual motion vector which is predicted using motion vectors of neighboring blocks as will be described with reference to FIG. 4.

Referring to FIG. 3, the virtual motion vector generation unit 120 can set a virtual motion vector MVᵥᵢᵣₜᵤₐₗ of the intra block E 300 equal to the result obtained by substituting motion vectors MVₐ, MV_{b}, MV_{c}, and MV_{d} of the neighboring blocks A through D 310 through 340, in a function F as in equation 1 below:

MV_{virtual E}=F(MVₐ,MV_{b},MV_{c},MV_{d}) (1)

The function F may be a function for obtaining a median or mean of motion vectors MVₐ, MV_{b}, MV_{c}, and MV_{d} of the neighboring blocks A through D 310 through 340 or a function for multiplying each of the motion vectors MVₐ, MV_{b}, MV_{c}, and MV_{d} by a predetermined weight and adding the results as in equation 2 below:

MV_{virtual E}=α·MVₐ+β·MV_{b}+σ·MV_{c}+λ·MV_{d} (2)

As described above, when an intra block is included in the neighboring blocks A through D 310 through 340, a virtual motion vector of the intra block is used as a motion vector in equations 1 and 2.

Also, neighboring blocks and the number of motion vectors used to generate a virtual motion vector of an intra block may be changed. A virtual motion vector of a current block is generated using motion vectors of a block above the current block, a block to the left of the current block, and a block above and to the right of the current block, which are used to predict a motion vector according to the conventional H.264 standard. If one of these blocks is an intra block, a virtual motion vector of the intra block is used as the motion vector of the intra block, thereby generating the virtual motion vector of the intra block in a manner similar to the motion vector prediction process of the conventional H.264 standard.

Referring back to FIG. 1, virtual motion compensation for the intra block is performed using the virtual motion vector generated by the virtual motion compensation unit 130, and a second prediction block is then generated. Referring to FIG. 2, the virtual motion compensation unit 130 obtains data on the corresponding area 260 of the reference frame 250 indicated by the virtual motion vector MVᵥᵢᵣₜᵤₐₗ of the intra block 220, to generate a first prediction block of the intra block 220.

The intra prediction unit 110 performs intra prediction in a current frame, to generate the second prediction block corresponding to the current block.

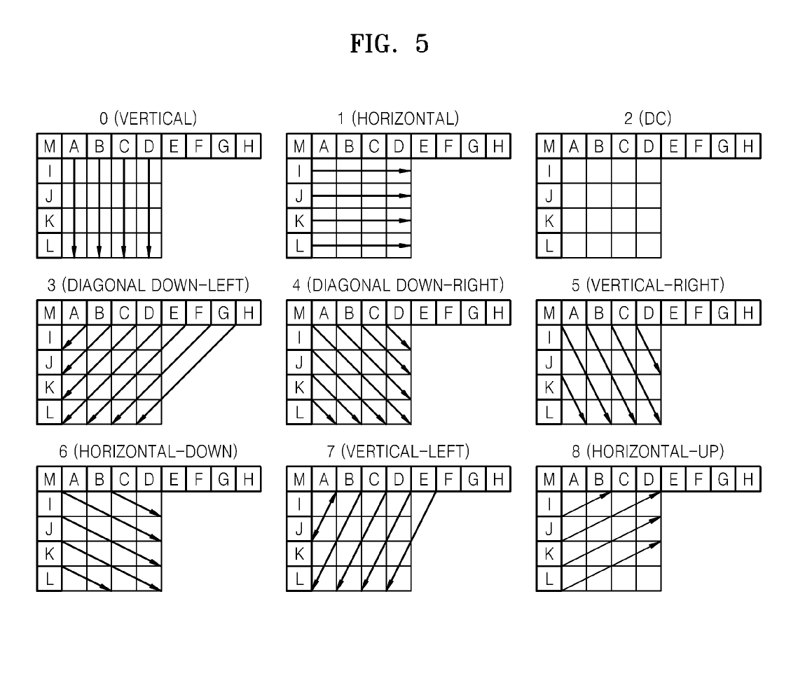

FIG. 4 illustrates 4×4 intra prediction modes according to an exemplary embodiment of the present invention. FIG. 5 illustrates 16×16 intra prediction modes according to an exemplary embodiment of the present invention.

Referring to FIG. 4, 4×4 intra prediction modes include a vertical mode, a horizontal mode, a direct current (DC) mode, and a plane mode. Referring to FIG. 5, 16×16 intra prediction modes include a vertical mode, a horizontal mode, a DC mode, a diagonal down-left mode, a diagonal down-right mode, a vertical-right mode, a vertical-left mode, a horizontal-up mode, and a horizontal-down mode.

For example, an operation of prediction-encoding a 4×4 current block is described according to a mode 0, i.e. the vertical mode of FIG. 4. Values of neighboring pixels A through D above the 4×4 current block are predicted as pixel values of the 4×4 current block. The value of the pixel A is predicted as the values of four pixels included in the first column of the 4×4 current block, the value of the pixel B is predicted as the values of four pixels included in the second column of the 4×4 current block, the value of the pixel C is predicted as the values of four pixels included in the third column of the 4×4 current block, and the value of the pixel D is predicted as the values of four pixels included in the fourth row of the 4×4 current block. Thereafter, a difference value is obtained by subtracting the pixel values of the 4×4 current block predicted using the pixels A through D from the original pixel values of the 4×4 current block, and then encoded.

The intra prediction method illustrated in FIGS. 4 and 5 is based on the H.264 standard. The intra prediction unit 110 can generate the first prediction block by performing different intra prediction that uses neighboring pixels in the same frame, besides the conventional intra prediction method.

The combination unit 140 combines the first prediction block generated by the virtual motion compensation unit 130 and second prediction block generated by the intra prediction unit 110 to generate a final prediction block. A variety of methods may be used to combine the first prediction block and the second prediction block. According to an exemplary embodiment, the final prediction block can be generated by calculating the mean of the pixel value of the first prediction block and the pixel value of the second prediction block corresponding to the first prediction block, or by multiplying a weight by each of the pixel values of the first prediction block and the pixel values of the second prediction block and adding the products. In more detail, if the first prediction block and the second prediction block respectively have pixel values p1(a, b) and p2(a, b), at a location (a, b), the combination unit 140 generates the final prediction block having the mean of corresponding pixel values such as {p1(a,b)+p2(a,b)}/2, or having the sum of results obtained by multiplying the predetermined weight (α, β) by the pixel values corresponding to the first prediction block and the second prediction block such as {α×p1(a,b)+β×p2(a,b)}. The weight (α, β) can be established as α=i/N, and β=j/N, wherein i denotes the number of inter prediction encoded blocks, and j denotes the number of intra prediction encoded blocks among n (n is a positive integer) blocks neighboring the current intra block.

The residual coding unit 150 compares the cost of a bitstream generated by encoding a block generated by intra prediction with the cost of a bitstream generated by encoding the final prediction block that is a combination of the prediction block by virtual motion compensation according to the present invention and the prediction block by intra prediction, to determine whether to encode the intra block in a general intra prediction mode or in a prediction mode in combination with the virtual motion compensation according to an exemplary embodiment of the present invention. The costs can be calculated in various manners using different cost functions, such as a sum of absolute difference (SAD) cost function, a sum of absolute transformed difference (SATD) cost function, a sum of squared difference (SSD) cost function, a mean of absolute difference (MAD) cost function, and a Lagrange cost function.

A flag indicating whether the final prediction block has been encoded may be inserted into a header of a bitstream to be encoded according to an image encoding method according an exemplary embodiment of the present invention. The final prediction block is a combination of the first prediction block by the virtual motion compensation and the second prediction block by the intra prediction.

The reconstruction unit 160 performs inverse quantization and inverse transformation of quantized block data and reconstructs the block data. The reconstructed data is used to predict the next block.

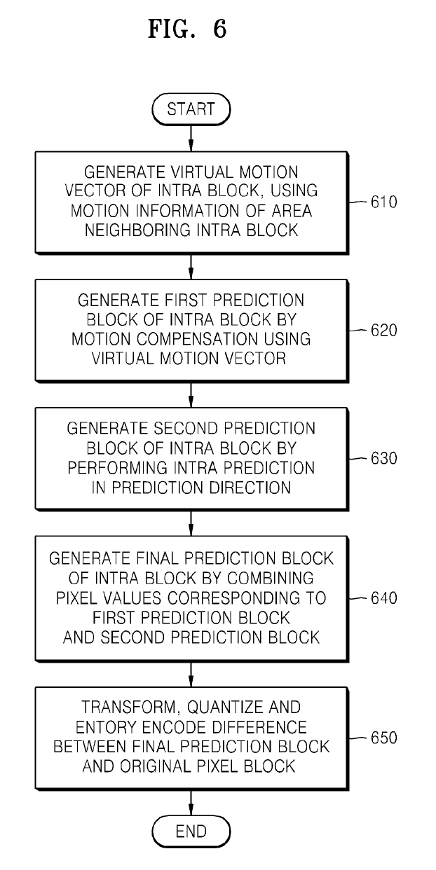

FIG. 6 is a flowchart illustrating an image encoding method according to an exemplary embodiment of the present invention. Referring to FIG. 6, motion information of an area neighboring an intra block that is intra prediction encoded, is used to generate a virtual motion vector of the intra block (Operation 610). The virtual motion vector can be generated by performing motion prediction using a previously encoded neighboring area before an intra block is encoded, or obtaining a median value or a mean value of motion vectors of blocks neighboring the intra block.

A first prediction block of the intra block is generated by performing motion compensation for obtaining a corresponding area of a reference frame indicated by the virtual motion vector (Operation 620).

A second prediction block of the intra block is generated by performing general intra prediction using a pixel of the previously encoded neighboring block (Operation 630).

A final prediction block of the intra block is generated by combining pixel values corresponding to the first prediction block and the second prediction block (Operation 640). The final prediction block can be generated using a mean value or the weighted sum of the pixel values corresponding to the first prediction block and the second prediction block.

A residual block, that is the difference between the final prediction block and an original pixel block, is transformed, quantized, and entropy-encoded, thereby generating a bitstream (Operation 650).

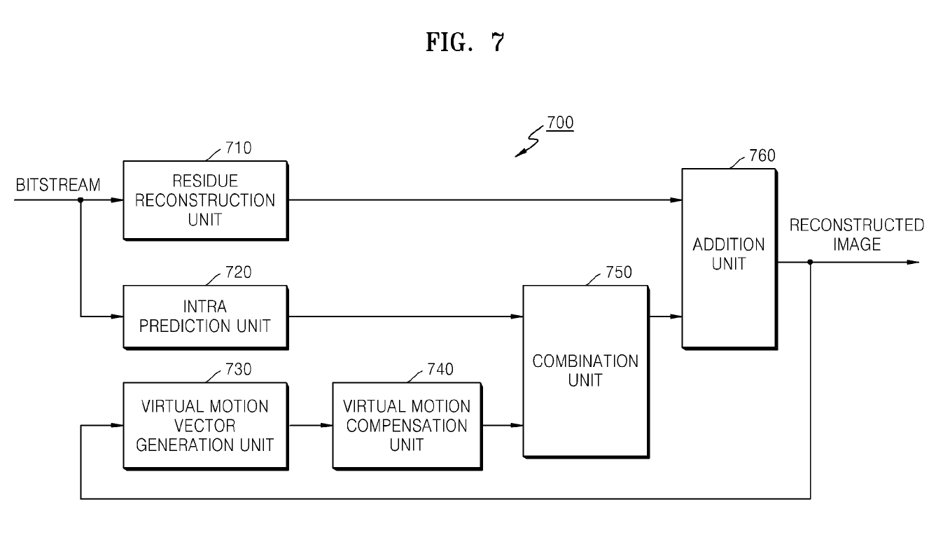

FIG. 7 is a block diagram of an image decoding apparatus 700 according to an exemplary embodiment of the present invention. Referring to FIG. 7, the image decoding apparatus 700 includes a residue reconstruction unit 710, an intra prediction unit 720, a virtual motion vector generation unit 730, a virtual motion compensation unit 740, a combination unit 750, and an addition unit 760.

The residue reconstruction unit 710 performs entropy decoding, inverse quantization, and inverse transform on a residue, which is a prediction error between an input block included in a received bitstream and a final prediction block, thereby reconstructing the residue.

The intra prediction unit 720 reads intra prediction mode information from the bitstream and performs intra prediction for a current block that is being currently decoded.

The virtual motion vector generation unit 730 generates a virtual motion vector of an intra block, by using motion information of an area neighboring the intra block. The operation of the motion vector generation unit 730 illustrated in FIG. 7 is similar to that of the virtual motion vector generation unit 120 illustrated in FIG. 1. That is, the motion vector generation unit 730 sets the virtual motion vector equal to a motion vector which is generated by performing motion estimation for the area neighboring the intra block, or a vector value which is generated by substituting motion vectors of previously decoded blocks neighboring the intra block before the intra block is decoded in a predetermined function.

The virtual motion compensation unit 740 generates a prediction block of the intra block, by motion compensation for obtaining corresponding image data of a reference picture indicated by the virtual motion vector of the inter block.

The combination unit 750 combines a prediction block generated by virtual motion compensation and another prediction block generated by intra prediction, and generates a final prediction block. The addition unit 760 adds the final prediction block to the residue, and generates a reconstructed block image.

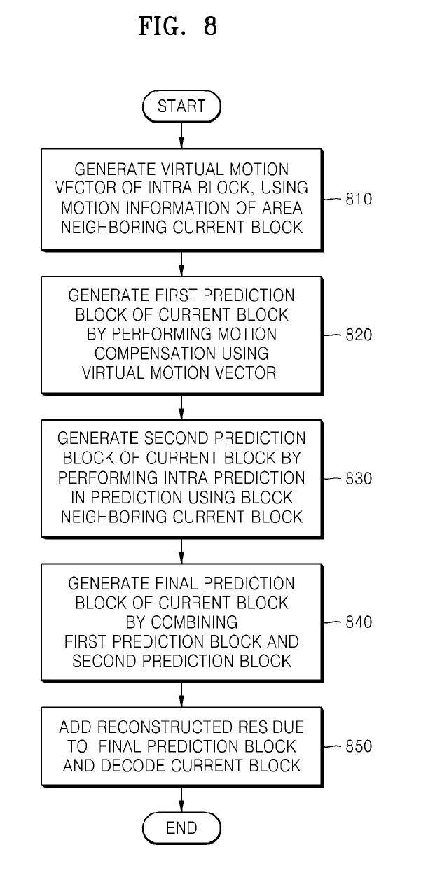

FIG. 8 is a flowchart illustrating an image decoding method according to an exemplary embodiment of the present invention. Referring to FIG. 8, motion information on an area neighboring a current block is used to generate a virtual motion vector of the current block (Operation 810). The virtual motion vector is set equal to a motion vector which is generated by performing motion estimation for the area neighboring the current block, or a vector value which is generated by substituting motion vectors of previously decoded blocks neighboring the current block before the current block is decoded in a predetermined function.

A first prediction block of the current block is generated by performing motion compensation for obtaining area data of a reference frame indicated by the virtual motion vector (Operation 820).

A second prediction block of the current block is generated by performing intra prediction using a previously decoded neighboring block (Operation 830). The second prediction block is generated in the same manner as general intra prediction, and thus a detailed description thereof is omitted.

A final prediction block of the current block is generated by combining the first prediction block and the second prediction block (Operation 840). The final prediction block can be generated using the mean or the weighted sum of the pixel values corresponding to the first prediction block and the second prediction block.

A reconstructed residue is added to the final prediction block, thereby decoding the current block (Operation 850).

The image encoding method and apparatus according to an exemplary embodiment of the present invention assign a virtual motion vector generated using motion information of an area neighboring an intra block to the intra block, generate a final prediction block, that is a combination of a prediction block generated by motion compensation using the virtual motion vector and another prediction block generated by intra prediction, and encode a residual block that is a difference between an original pixel block and the final prediction block, thereby improving prediction efficiency according to the image characteristics.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

Exemplary embodiments of the present invention improve prediction efficiency according to the image characteristics by means of a new prediction mode that is a combination of the conventional intra prediction mode and inter prediction mode, thereby reducing a bitrate.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An image encoding method comprising:
generating a virtual motion vector of an intra block which is encoded by intra prediction, based on motion information of an area neighboring the intra block;
generating a first prediction block of the intra block by performing motion compensation using the virtual motion vector;
generating a second prediction block of the intra block by performing intra prediction for the intra block in a prediction direction;
generating a final prediction block of the intra block by combining the first prediction block and the second prediction block.

2. The method of claim 1, wherein the generating the virtual motion vector of the intra block comprises:
performing motion estimation of the area neighboring the intra block; and
setting the virtual motion vector of the intra block to be equal to a motion vector having a same magnitude and direction as a motion vector of the area neighboring the intra block.

3. The method of claim 1, wherein the generating the virtual motion vector of the intra block comprises:
setting the virtual motion vector of the intra block to be equal to a vector generated by substituting motion vectors of blocks neighboring the intra block, in a function.

4. The method of claim 3, wherein the function provides a median value of the motion vectors of the blocks neighboring the intra block.

5. The method of claim 3, wherein the function provides a weighted sum of the motion vectors, which is obtained by multiplying the motion vectors of the blocks neighboring the intra block by weights and adding products of the multiplying.

6. The method of claim 1, wherein the area neighboring the intra block comprises at least one block which has been previously encoded and reconstructed before an inter block is encoded.

7. The method of claim 1, wherein the generating the final prediction block of the intra block comprises calculating a mean of a pixel value of the first prediction block and a pixel value of the second prediction block corresponding to the pixel value of the first prediction block.

8. The method of claim 1, wherein the generating the final prediction block of the intra block comprises:
multiplying a weight by each of pixel values of the first prediction block and each of pixel values corresponding to the second prediction block and adding products of the multiplying.

9. An image encoding apparatus comprising:
a virtual motion vector generator which generates a virtual motion vector of an intra block which is encoded by intra prediction, based on motion information of an area neighboring the intra block;
a motion compensation unit which generates a first prediction block of the intra block by performing motion compensation using the virtual motion vector;
an intra prediction unit which generates a second prediction block of the intra block by performing intra prediction for the intra block in a prediction direction; and
a combination unit which generates a final prediction block of the intra block by combining the first prediction block and the second prediction block.

10. The apparatus of claim 9, wherein the virtual motion vector generator performs motion estimation of the area neighboring the intra block, and sets the virtual motion vector of the intra block to be equal to a motion vector having a same magnitude and direction as a motion vector of the area neighboring the intra block.

11. The apparatus of claim 9, wherein the virtual motion vector generator sets the virtual motion vector of the intra block to be equal to a vector generated by substituting motion vectors of blocks neighboring the intra block, in a function.

12. The apparatus of claim 11, wherein the function outputs a median value of the motion vectors of the blocks neighboring the intra block.

13. The apparatus of claim 11, wherein the function outputs a weighted sum of the motion vectors, which is obtained by multiplying the motion vectors of the blocks neighboring the intra block by predetermined weights and adding products of the multiplying.

14. The apparatus of claim 9, wherein the area neighboring the intra block comprises at least one block which has been previously encoded and reconstructed before the inter block is encoded.

15. The apparatus of claim 9, wherein the combination unit calculates a mean value of a pixel value of the first prediction block and a pixel value of the second prediction block corresponding to the pixel value of the first prediction block.

16. The apparatus of claim 9, wherein the combination unit multiplies a weight by each of pixel values of the first prediction block and each of pixel values corresponding to the second prediction block and adds products of the multiplication.

17. An image decoding method comprising:
generating a virtual motion vector of a current block that is to be decoded using motion information on an area neighboring the current block;
generating a first prediction block of the current block by performing motion compensation using the virtual motion vector;
generating a second prediction block of the current block by performing intra prediction using a previously decoded block neighboring the current block before the current block is decoded;
generating a final prediction block of the current block by combining the first prediction block and the second prediction block; and
decoding the current block by reconstructing a residue included in a received bitstream and adding the residue to the final prediction block.

18. The method of claim 17, wherein the final prediction block comprises a mean value of pixel values between the first prediction block and the second prediction block.

19. The method of claim 17, wherein the final prediction block comprises a weighted sum obtained by multiplying a predetermined weight by each of pixel values corresponding to the first prediction block and the second prediction block and adding products of the multiplying.

20. An image decoding apparatus comprising:
a virtual motion vector generation unit which generates a virtual motion vector of a current block that is to be decoded using motion information on an area neighboring the current block; a motion compensation unit which generates a first prediction block of the current block by performing motion compensation using the virtual motion vector;
an intra prediction unit which generates a second prediction block of the current block by performing intra prediction using a previously decoded block neighboring the current block before the current block is decoded;
a combination unit which generates a final prediction block of the current block by combining the first prediction block and the second prediction block;
a residue reconstruction unit which reconstructs a residue included in a received bitstream; and
an addition unit which decodes the current block by adding the residue to the final prediction block.

21. The apparatus of claim 20, wherein the combination unit calculates a mean value of pixel values between the first prediction block and the second prediction block to generate the final prediction block of the current block.

22. The apparatus of claim 20, wherein the combination unit multiplies a weight by each of the pixel values corresponding to the first prediction block and the second prediction block and adds products of the multiplication to generate the final prediction block of the current block.
